(19) United States
(12) Patent Application Publication
(10) Pub. No.: US 2008/0116760 A1
(43) Pub. Date: May 22, 2008

(54) Electric rotating machine with armature coil

(75) Inventors: Akifumi Hosoya, Anjo-shi (JP); Tadahiro Kurasawa, Chita-gun (JP); Kazuhiro Andoh, Okazaki-shi (JP)

Correspondence Address: OLIFF & BERRIDGE, PLC, P.O. BOX 320850, ALEXANDRIA, VA, 22320-4850, US

(73) Assignee: DENSO CORPORATION, KARIYA- CITY (JP)

(21) Appl. No.: 11/979,704

(22) Filed: Nov. 7, 2007

(30) Foreign Application Priority Data
Nov. 21, 2006 (JP) 2006-314686

(51) Int. Cl. H02K 3/48; H02K 1/26

(52) U.S. Cl. 310/214; 310/264

(57) ABSTRACT

An electric rotating machine has a stator generating a magnetic flux and a rotor with a columnar armature core and an armature coil wound on the core. The flux passes through the rotor. The rotor is rotatable around its center axis. The core has slots aligned along its circumferential direction. Each slot extends along an axial direction of the core. The coil has upper layer coil parts and lower layer coil parts alternately connected with one another. Each pair of upper and lower layer coil parts is received in one slot so as to place the lower layer coil part nearer to the center axis of the core than the upper layer coil part. A sectional area of the upper layer coil part received in each slot is larger than a sectional area of the lower layer coil part received in the slot.

### CROSS-REFERENCE TO RELATED APPLICATION

This application is based upon and claims the benefit of priority of the prior Japanese Patent Application 2006-314686 filed on Nov. 21, 2006 so that the contents of which are incorporated herein by reference.

### BACKGROUND OF THE INVENTION

1. Field of the Invention

The present invention relates to an electric rotating machine wherein a rotor with an armature coil is rotated in response to an electric current flowing through the armature coil, or a current is generated in the armature coil in response to a rotation of the rotor caused by an external force.

2. Description of Related Art

An electric rotating machine has a cylindrical stator having fixed magnetic poles aligned along a circumferential direction thereof, a columnar rotor with an armature coil, and a yoke holding the stator. The rotor is disposed within a center space of the stator with an opening between the rotor and the stator. When an electric current flows through the armature coil while cyclically changing a flow direction of the current in the coil, the current crosses a magnetic field induced by each pair of magnetic poles of the stator. Therefore, the rotor is rotated along the circumferential direction.

An electric rotating machine is, for example, disclosed in Published Japanese Patent First Publication No. H08-140324. A rotor of this machine has a shaft, a columnar armature core fixed to the shaft, and an armature coil wound on the core. The armature core is composed of a plurality of ring-shaped core plates laminated along an axial direction of the shaft. Each plate is formed of a thin metallic steel disc. The core has a center hole into which the shaft is fixedly inserted. The core further has twenty-five slots aligned at equal intervals along a circumferential direction of the core on an outer circumferential surface of the core. Each slot extends along the axial direction and is formed in a rectangular shape in section. The armature coil is made of copper and is received in the slots so as to be wound on the core.

The armature coil is composed of twenty-five upper layer coil bars forming an upper layer coil and twenty-five lower layer coil bars forming a lower layer coil. The upper layer coil bars and the lower layer coil bars are alternately connected with one another to form a series of coil bars. Each upper layer coil bar has an upper layer coil side portion and two upper layer coil end portions, respectively, connected to both ends of the side portion. Each lower layer coil bar has a lower layer coil side portion and two lower layer coil end portions, respectively, connected to both ends of the side portion. Each of the side portions is formed of a straight bar having a rectangular shape in section. The upper layer coil side portions are received in upper layers of the slots of the core, respectively. The lower layer coil side portions are received in lower layers of the slots of the core, respectively. The upper and lower layer coil side portions received in the same slot are adjacent to each other in a radial direction of the shaft, and the lower layer coil side portion is disposed nearer to the shaft than the upper layer coil side portion.

To electrically insulate the side portions and the core from one another, insulating films are used. More specifically, each upper layer coil side portion is covered with an upper layer insulating film, and a lower layer insulating film covers a block of the lower layer coil side portion and the upper layer coil side portion disposed in each slot. Therefore, the upper and lower layer coil side portions in each slot are insulated from each other by the upper layer insulating film, each lower layer coil side portion is insulated from the core by the lower layer insulating film, and each upper layer coil side portion is insulated from the core by the upper and lower layer insulating films.

With this arrangement in the rotor of the electric rotating machine, an electric current passes through a series of upper and lower layer coil bars, and the rotor is rotated. In this case, heat is inevitably generated in each of the upper and lower layer coil bars receiving the same level of electric current, and this heat is required to be dissipated to the outside of the machine to stably operate the machine.

Because a thickness of the films covering each upper layer coil side portion is larger than a thickness of the film covering the corresponding lower layer coil side portion, a sectional area of the upper layer coil side portion becomes smaller than that of the lower layer coil side portion by a sectional area of the upper layer insulating film. Therefore, electrical resistance per a unit length in the upper layer coil side portion becomes larger than that in the lower layer coil side portion. As a result, because the length of the upper layer coil side portion is almost the same as the length of the lower layer coil side portion, heat generated in the upper layer coil side portions becomes higher than that in the lower layer coil side portions.

Further, the lower layer coil side portions are disposed to be nearer to the shaft than the upper layer coil side portions, and a heat capacity of the shaft connected with the armature core is considerably larger than that of the armature coil. Therefore, heat generated in the lower layer coil side portions can efficiently be conducted to the shaft through the core more than heat of the upper layer coil side portions. That is, heat of the lower layer coil side portions can efficiently be dissipated to the outside of the machine through the shaft, as compared with heat of the upper layer coil side portions.

Moreover, permanent magnets and a yoke holding the magnets are disposed on the outer side of the rotor in the radial direction so as to face the rotor through an opening. Because of the existence of the opening, heat transfer from the upper layer coil side portions to the magnets and the yoke is considerably lower than the heat conductance from the upper layer coil side portions to the shaft. As a result, heat dissipation from the upper layer coil side portions becomes lower than that from the lower layer coil side portions.

Therefore, because a heat dissipation performance for the upper layer coil side portions is degraded as compared with that for the lower layer coil side portions, the upper layer coil side portions generating heat larger than heat of the lower layer coil side portions are undesirably heated to a high temperature. In this case, there is a high probability that the insulating films covering the upper layer coil side portions may be melted so as to break the insulation from the core or the lower layer coil side portions.

Particularly, the electric rotating machine has recently been operated such that a high level of electric current flows through the armature coil for a long time to heighten an output (electric power or driving force) of the machine. Therefore, heat generated in the armature coil has been increased. To reliably operate the machine without short circuits among the upper and lower layer coil side portions and the core, the armature coil is sometimes covered with an insulating film having a high heat resistance, or the armature core is sometimes sized up to increase the number of coil side portions so as to lower a level of current flowing through each coil side portion or to efficiently transmit heat of the armature coil to the core.

However, when an insulating film having a high heat resistance is used for the armature coil, a cost of the machine is undesirably heightened. Further, when the armature core is sized up, a size of the machine becomes larger than a size for a required output of the machine so as to heighten the manufacturing cost of the machine.

### SUMMARY OF THE INVENTION

An object of the present invention is to provide, with due consideration to the drawbacks of the conventional electric rotating machine, an electric rotating machine which reliably reduces a temperature rise in an armature coil of a rotor without enlarging a size of the machine.

According to an aspect of this invention, the object is achieved by the provision of an electric rotating machine comprising a rotor and a stator generating a magnetic flux passing through the rotor. The rotor comprises an armature core substantially formed in a columnar shape and an armature coil wound on the armature core. The armature core is rotatable around its center axis. The armature core has a plurality of slots aligned along a circumferential direction of the core. Each slot extends substantially along an axial direction of the core. Each slot has an upper region and a lower region nearer to the center axis of the core than the upper region. The armature coil has a plurality of upper layer coil parts and a plurality of lower layer coil parts connected with one another. The upper layer coil parts are received in the upper regions of the slots, respectively. The lower layer coil parts are received in the lower regions of the slots, respectively. A sectional area of the upper layer coil part received in each slot is set to be larger than a sectional area of the lower layer coil part received in the slot.

With this structure of the machine, when an electric current with a level changing with time flows through the coil, the rotor with the coil is rotated, and a rotational force of the rotor is outputted. In contrast, when an external force is given to the rotor so as to rotate the rotor placed in a magnetic flux, the coil is moved in the magnetic flux, and an alternating current is generated in the coil. The current is outputted.

Further, the coil is heated due to an electric resistance of the coil in response to the current flowing through the coil, and heat of the coil is dissipated through the core having a large heat capacity. Because the upper layer coil part received in each slot are placed further away from the center axis of the core than the lower layer coil part received in the slot, the upper layer coil part is inferior to the lower layer coil part in heat dissipation. In contrast, because a sectional area of the upper layer coil part received in each slot is larger than a sectional area of the lower layer coil part received in the slot, an electric resistance of the upper layer coil part is lower than that of the lower layer coil part so as to set an amount of heat generated in the upper layer coil part to be lower than that generated in the lower layer coil part.

Therefore, although the upper layer coil part is inferior in heat dissipation, an increase of the temperature of the upper layer coil part can be set to be substantially equal to an increase of the temperature of the lower layer coil part. Accordingly, the machine can reliably reduce a temperature rise in the armature coil without enlarging a size of the machine, and the machine requires no insulating film having a high heat resistance for insulating the upper and lower layer coil parts and the core from one another.

### BRIEF DESCRIPTION OF THE DRAWINGS

FIG. 1 is a longitudinal sectional view, with portions broken away, of an electric rotating machine, taken substantially along an axial direction of the machine, according to embodiments of the present invention;

FIG. 2 is a plan view of an armature core shown in FIG. 1;

FIG. 3A is a side view of an upper layer coil part of an armature coil shown in FIG. 1 according to a first embodiment of the present invention;

FIG. 3B is a back view of the upper layer coil part shown in FIG. 3A;

FIG. 4A is a side view of a lower layer coil part of an armature coil shown in FIG. 1 according to the first embodiment;

FIG. 4B is a back view of the lower layer coil part shown in FIG. 4A;

FIG. 5 is a sectional view of portions of an armature coil received in a slot of the armature core according to the first embodiment;

FIG. 6 is a perspective side view of the upper layer coil part and the lower layer coil part connected with each other;

FIG. 7 is a plan view of the armature core on which an armature coil is wound; and

FIG. 8 is a sectional view of an armature coil received in a slot of the armature core according to a second embodiment of the present invention.

### DETAILED DESCRIPTION OF THE PREFERRED EMBODIMENTS

Embodiments of the present invention will now be described with reference to the accompanying drawings, in which like reference numerals indicate like parts, members or elements throughout the specification unless otherwise indicated.

### Embodiment 1

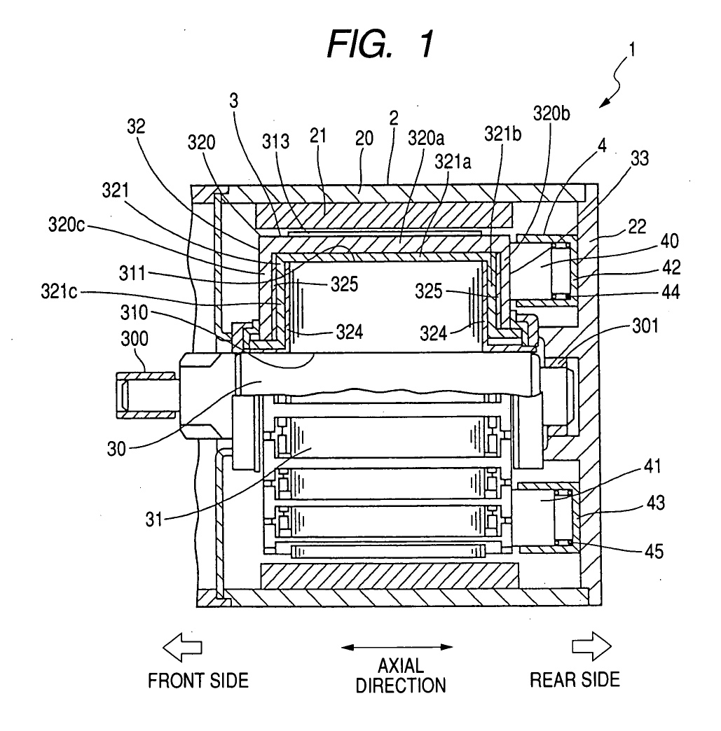

A structure of an electric rotating machine is now described with reference to FIG. 1. FIG. 1 is a longitudinal sectional view, with portions broken away, of an electric rotating machine, taken substantially along an axial direction of the machine.

An electric rotating machine is, for example, disposed on a vehicle to produce a rotational force from electric power as a motor of a starter or to produce electric power from a rotational force as a generator. As shown in FIG. 1, an electric rotating machine 1 has a stator 2 formed almost in a cylindrical shape, a rotor 3 disposed in a center space of the stator 2, a brush apparatus 4 disposed on a rear side of the stator 2 to supply an electric current to the rotor 3, and an end frame 22 to which the apparatus 4 is fixed.

The rotor 3 has a columnar shaft 30 rotatably supported by the frame 22 through bearings 300 and 301, an armature core 31 formed in a columnar shape and fixed to the shaft 30 so as to be rotated with the shaft 30, an armature coil 32 wound on the core 31, and a commutator 33 disposed between the coil 32 and the brush apparatus 4. The commutator 33 periodically changes a flow direction of an electric current supplied from the apparatus 4 in cooperation with the apparatus 4 and provides the current to the coil 32, or the commutator 33 periodically changes a flow direction of an electric current generated in the coil 32 in cooperation with the apparatus 4 and outputs the current to a battery (not shown) of a vehicle through the apparatus 4. The shaft 30 is made of a metal having a high thermal conductivity so as to efficiently dissipate heat transmitted from the core 31.

The stator 2 has a cylindrical case 20 made of a magnetic substance and a plurality of permanent magnets 21 fixed to an inner circumferential surface of the case 20. The magnets 21 are aligned along a circumferential direction of the core 31 at equal intervals so as to alternately arrange N and S magnetic poles of the magnets 21 along the circumferential direction. Each magnet 21 is formed of an arc-shaped disc. The magnets 21 generate magnetic fluxes passing through the rotor 3, and the case 20 forms magnetic paths of the fluxes to reinforce the fluxes. The case 20 accommodates the rotor 3 and the brush apparatus 4 therein such that inner circumferential surfaces of the magnets 21 face an outer circumferential surface of the core 31 through an opening. The frame 22 is almost formed in a disc shape and is fixed to a rear end of the case 20.

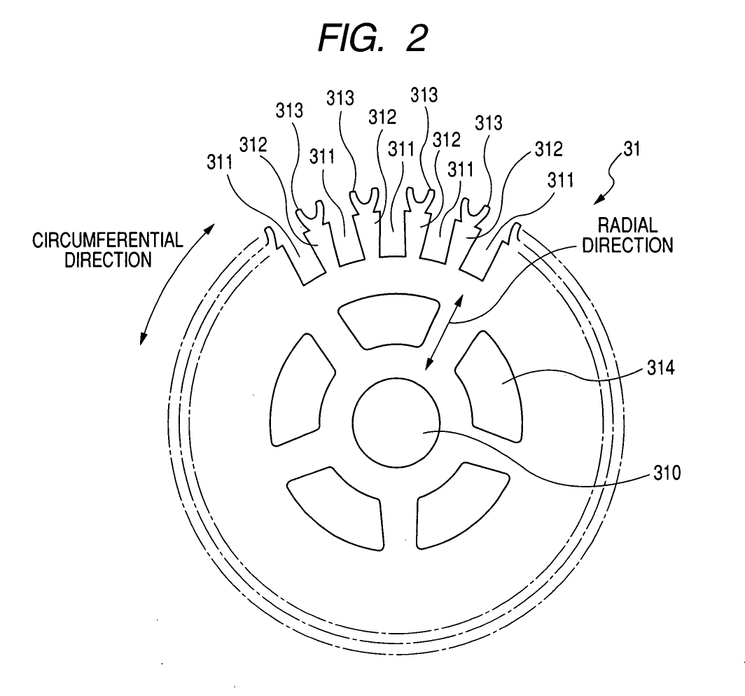

FIG. 2 is a plan view of the armature core 31 shown in FIG. 1. As shown in FIG. 2, the core 31 is formed of a plurality of disc-shaped members laminated along an axial direction of the shaft 30. Each member is made of a magnetic substance pressed and shaped by a metallic mold, and the core 31 forms magnetic paths of the fluxes to reinforce the fluxes. The core 31 has a center through-hole 310 extending along the axial direction, and the shaft 30 is fixedly inserted into the hole 310. The core 31 has a plurality of slots 311 aligned along the circumferential direction at equal intervals on an outer circumferential surface thereof. Each slot 311 is obtained by caving an outer circumferential portion of the core 31 along a radial direction of the core 31 almost in a rectangular shape in section. Each slot 311 extends almost along the axial direction. The armature coil 32 is disposed in the slots 311 as described in detail. The core 31 has a tooth portion 312 disposed between the slots 311 in each pair so as to alternately arrange the portions 312 and the slots 311 along the circumferential direction. The tooth portions 312 form a magnetic path of the magnetic fluxes. Each tooth portion 312 has a V-shaped fixing claw 313 on an outer circumferential side thereof. After the coil 32 is received in the holes 311, each claw 313 is bent toward the shaft 30 so as to fix the coil 32 to the core 31 in the slots 311. The core 31 also has a plurality of holes 314 to lighten the core 31 in weight.

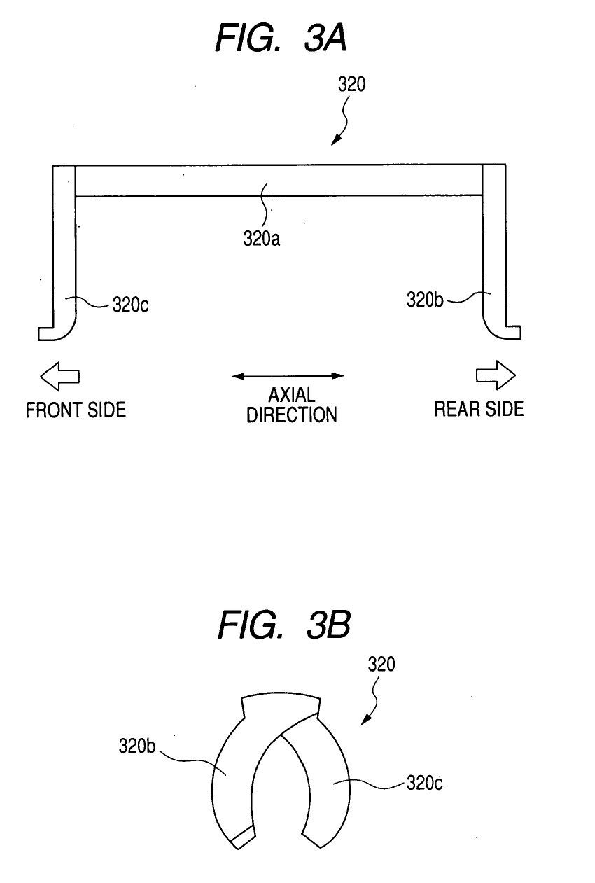

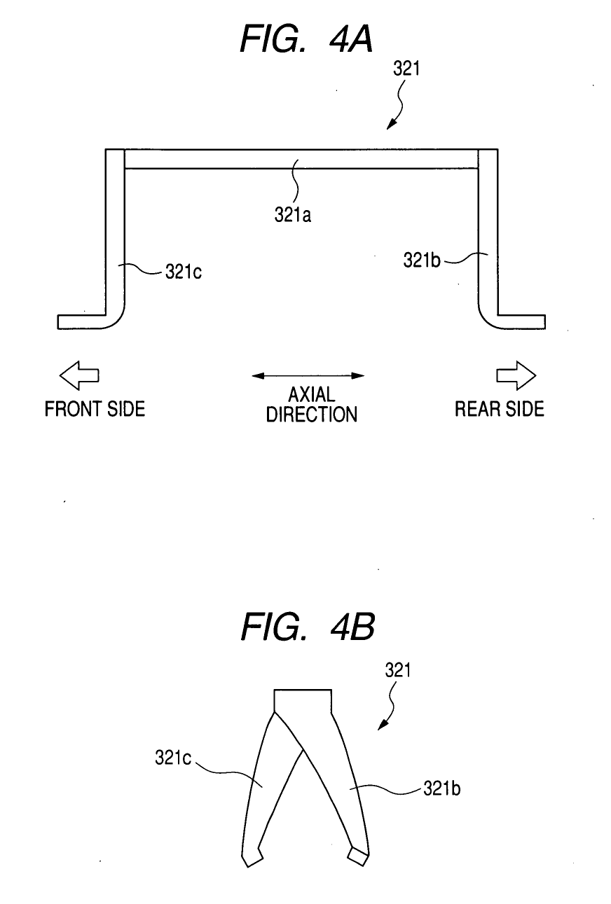

FIG. 3A is a side view of an upper layer coil part of the coil 32, while FIG. 3B is a back view of the upper layer coil part. FIG. 4A is a side view of a lower layer coil part of the coil 32, while FIG. 4B is a back view of the lower layer coil part.

The coil 32 is composed of a plurality of upper layer coil parts 320 and a plurality of lower layer coil parts 321 alternately connected with one another in series so as to form a closed loop. Each of the coil parts 320 and 321 is made of copper. As shown in FIG. 3A and FIG. 3B, each coil part 320 has a slot-received portion (or intermediate portion) 320a and two linking portions (or end portions) 320b and 320c, respectively, connected with ends of the portion 320a. The portion 320a is formed in a bar shape and almost in a rectangular shape in section so as to have two longer sides and two shorter sides. The portions 320a are received in the slots 311, respectively. Each of the linking portions 320b and 320c extends along a radial direction of the core 31 and is bent in an arc shape. The linking portions 320b are disposed on an end surface of the core 31 on the rear side of the machine 1. The linking portions 320c are disposed on another end surface of the core 31 on the front side of the machine 1.

As shown in FIG. 4A and FIG. 4B, each coil part 321 has a slot-received portion (or intermediate portion) 321a and two linking portions (or end portions) 321b and 321c, respectively, connected with ends of the portion 321a. The portion 321a is formed in a bar shape and almost in a regular square in section so as to have four sides set at the same length. The portions 321a are received in the slots 311, respectively. A length of the portion 321a is substantially the same as a length of the portion 320a received in the same slot 311 as the portion 321a. A length of each side of the portion 321a is almost the same as a length of a shorter side of the portion 320a. Therefore, a length of each side of the portion 321a is smaller than a length of a longer side of the portion 320a, and a sectional area of the portion 320a is larger than a sectional area of the portion 321a. Each of the linking portions 321b and 321c extends along the radial direction and is bent in an arc shape. The linking portions 321b are disposed on the rear end surface of the core 31 on the rear side. The linking portions 321c are disposed on the front end surface of the core 31.

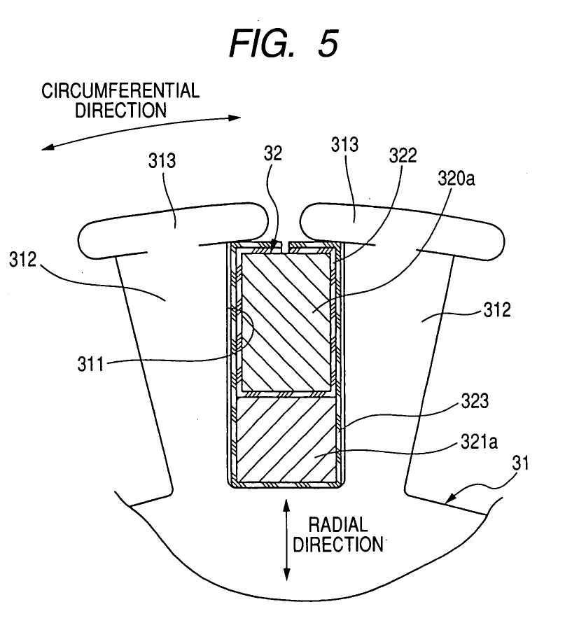

FIG. 5 is a sectional view of the portions 320a and 321a of the coil 32 received in one slot 311 of the core 31 according to a first embodiment. As shown in FIG. 5, each slot 311 has an upper region and a lower region positioned along the radial direction, and the lower region is nearer to the shaft 30 (or a center axis of the core 32) than the upper region. The slot-received portions 320a of the coil 32 are, respectively, disposed in the upper regions of the slots 311 so as to form an upper layer of coils, and the slot-received portions 321a of the coil 32 are, respectively, disposed in the lower regions of the slots 311 so as to form a lower layer of coils. Each portion 320a formed in the rectangular shape is received in the slot 311 such that a longer side of the portion 320a is set to be parallel to the radial direction. Therefore, a shorter side of the portion 320a is perpendicular to the radial direction. Each portion 321a formed in the square shape is received in the slot 311 such that a side of the portion 321a is set to be parallel to the radial direction. Therefore, another side of the portion 321a is perpendicular to the radial direction. The fixing claws 313 are bent to close openings of the slots 311, so that the portions 320a and 321a are fixed to the core 31.

Because each portion 320a has a side longer than each side of the portion 321a, a sectional area of the portion 320a received in each slot 311 is set to be larger than that of the portion 321a received in the slot 311. Therefore, although the portion 320a is further away from the shaft 30 than the portion 321a such that the portion 320a is inferior to the portion 321a in heat dissipation, an electric resistance of the portion 320a becomes lower than that of the portion 321a so as to set an amount of heat generated in the portion 320a to be lower than that in the portion 321a.

For electric insulation, almost the whole outer circumferential surface of the portion 320a is covered with an upper layer insulating film 322, and almost the whole outer circumferential surface of both the portion 321a and the portion 320a covered with the film 322 is covered with a lower layer insulating film 323. Therefore, the portions 320a and 321a are insulated from each other by the film 322, the portion 321a is insulated from the core 31 by the film 323, and the portion 320a is insulated from the core 31 by the films 322 and 323.

Because the length of the shorter side of the portion 320a is almost the same as or is slightly smaller than the length of each side of the portion 321a, the coil 32 with the films 322 and 323 has a straight side parallel to the radial direction.

As shown in FIG. 1, to electrically insulate the linking portions 320b and 321b and the core 31 from one another, an insulating member 324 is disposed between the rear end surface of the core 31 and a group of linking portions 321b extending over the rear end surface of the core 31, and an insulating member 325 is disposed between the group of linking portions 321b and a group of linking portions 320b. To electrically insulate the linking portions 320c and 321c and the core 31 from one another, another insulating member 324 is disposed between the front end surface of the core 31 and a group of linking portions 321c extending over the front end surface of the core 31, and another insulating member 325 is disposed between the group of linking portions 321c and a group of linking portions 320c.

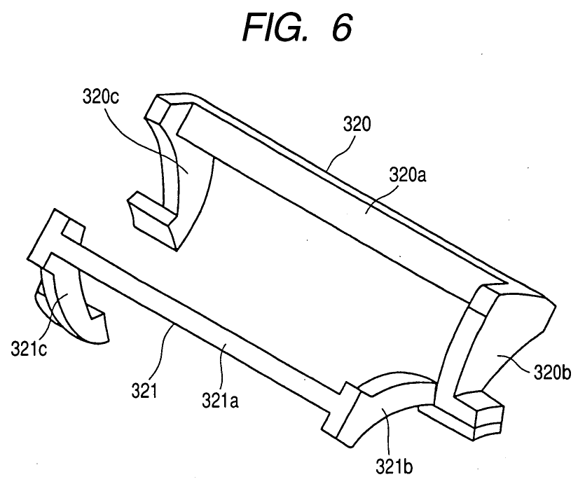

FIG. 6 is a perspective side view of the coil parts 320 and 321 connected with each other. As shown in FIG. 6, a top end of the linking portion 320b of each coil part 320 received in a first slot 311 is connected with a top end of the linking portion 321b of one coil part 321 received in a second slot 311 different from the first slot 311. Further, a top end of the linking portion 320c of the coil part 320 is connected with a top end of the linking portion 321c of another coil part 321 (not shown in FIG. 6) received in a third slot 311 different from the first and second slots 311. Therefore, the coil parts 320 and the coil parts 321 are alternately connected with one another in series to form the armature coil 32 in a coil shape.

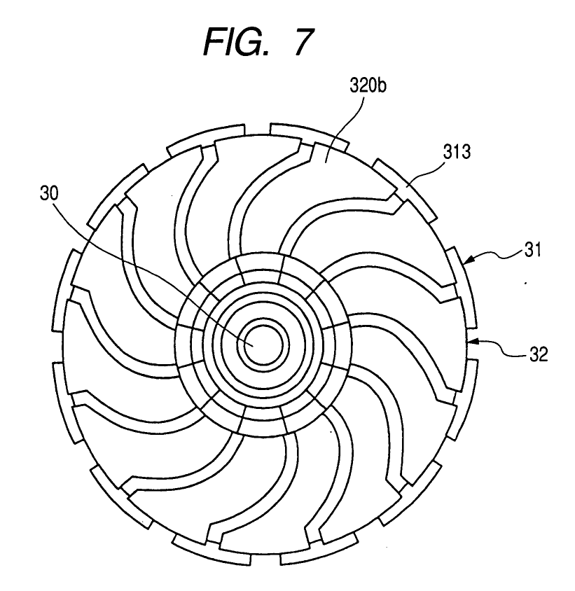

FIG. 7 is a plan view of the armature core 31 on which the armature coil 32 is wound. As shown in FIG. 7, the linking portions 320b of the coil parts 320 are disposed at equal intervals on the rear side of the core 31 so as to spirally extend from a center area near the shaft 30 to the outer circumferential surface of the core 31. In the same manner, the linking portions 320c of the coil parts 320 are disposed at equal intervals on the front side of the core 31.

Further, each linking portion 320b has a front flat surface facing the brush apparatus 4 such that the front surface extends on a plane perpendicular to the axial direction. With this structure, each of brushes of the apparatus 4 can smoothly make contact with the front surface of each linking portion 320b while a pair of portions 320b being contact with the apparatus 4 is changed to another pair with the rotation of the rotor 3. Therefore, the commutator 33 is constituted by the linking portions 320b.

As shown in FIG. 1, the brush apparatus 4 has brushes 40 and 41, brush holders 42 and 43, respectively, holding the brushes 40 and 41, and springs 44 and 45 for respectively pushing the brushes 40 and 41 toward a pair of the linking portions 320b acting as the commutator 33. Each of the brushes 40 and 41 is made of carbon having conductivity and is formed in a rectangular parallelepiped. Each of the brush holders 42 and 43 is made of resin having an insulation performance and is formed in a rectangular cylinder with a bottom. The holders 42 and 43 hold the brushes 40 and 41 so as to be able to reciprocate the brushes 40 and 41 along the axial direction. The bottoms of the holders 42 and 43 are fixed to an inner surface of the frame 22 so as to be opened toward the rotor 3. The springs 44 and 45 are accommodated in the holders 42 and 43 and have end portions attached to the bottoms of the holders 42 and 43 and other end portions attached to rear end portions of the brushes 40 and 41. The brushes 40 and 41 accommodated in the holders 42 and 43 are pushed toward the commutator 33 so as to make contact with the commutator 33.

Next, an operation of the machine 1 is now described below with reference to FIG. 1.

When a voltage is applied to the brushes 40 and 41, the machine 1 acts as a motor. That is, an electric current flows into the coil 32 through the commutator 33 while changing a flow direction. The current goes across magnetic fluxes generated by the magnets 21, the rotor 3 is rotated, and a rotational force of the rotor 3 is outputted to an external device placed outside the machine 1. When an external force is given to the rotor so as to rotate the rotor placed in a magnetic flux, the machine 1 acts as a generator. That is, the coil is moved in the magnetic flux, an alternating current is generated in the coil according to electromagnetic induction, the current is rectified in the commutator 33 and the apparatus 4, and the current is outputted to a battery.

During the operation of the machine 1, heat is mainly generated in the portions 320a and 321a due to electric resistance of the coil 32 in response to the current flowing through the coil 32. Because the portions 320a and 321a are connected with one another in series, a level of the current flowing through the portions 320a is the same as a level of the current flowing through the portions 321a. Further, the portions 320a and 321a received in the same slot 311 have the same length. Moreover, as shown in FIG. 5, the portion 320a is placed further away from the shaft 30 so as to lower a heat dissipation performance of the portion 320a as compared with that of the portion 321a. In contrast, a sectional area of the portion 320a received in each slot 311 is larger than that of the portion 321a received in the slot 311, so that an electric resistance of the portion 320a is lower than that of the portion 321a.

Therefore, although the low heat dissipation performance of the portion 320a is apt to heighten the temperature of the portion 320a, the low electric resistance of the portion 320a decreases an amount of heat generated in the portion 320a so as to reduce an increase of the temperature of the portion 320a. That is, the low electric resistance of the portion 320a acts to reduce a temperature rise of the portion 320a caused by the low heat dissipation performance. As a result, the portions 320a and the portions 321a are heated substantially at the same moderate temperature at which a general insulating film is not melted or damaged.

Accordingly, the machine 1 can reliably reduce a temperature rise in the armature coil 32 without enlarging a size of the machine 1, and the rotor 3 requires no insulating film having a high heat resistance. That is, an electric current flowing through the coil 32 can be maintained at a required level for a required operation time without lowering a level or an operation time to lower the temperature of the coil 32, so that the machine 1 can reliably output a required rotational force.

Further, assuming that the portion 320a has a similar figure in section to the portion 321a, widths of the portions 320a and 321a in the circumferential direction become different from each other to differentiate the sectional areas of the portions 320a and 321a from each other. In this case, an open space is formed in the slot 311 so as to degrade the performance of the machine 1 and/or to put the coil 32 in a movable condition. When the coil 32 is moved in the slot 311, there is a high probability that the insulating film 322 or 323 may be broken. However, in this embodiment, the portion 320a has a sectional shape differentiated from that of the portion 321a so as to equalize widths of the portions 320a and 321a in the circumferential direction to each other. Accordingly, the machine 1 can stably and efficiently be operated.

Moreover, because the portions 320a and 321a have the same width in the circumferential direction, the coil 32 can have a straight side surface parallel to the radial direction. Accordingly, the portions 320a and 321a can be reliably received in the slot 311 without forming an opening between the coil 32 and the core 31. This coil reception introduces an efficient production of the rotational force.

Furthermore, because a shorter side of the portion 320a having a rectangular shape in section is set to be perpendicular to the radial direction, the width of the coil 32 in the circumferential direction can be shortened as compared with a case where a longer side of the portion 320a is perpendicular to the radial direction. Accordingly, each tooth portion 312 can secure a sufficient width in the circumferential direction to sufficiently reinforce the magnetic fluxes, and the machine 1 can efficiently produce the rotational force or electric power.

In this embodiment, the coil 32 is disposed in each slot 311 to be partitioned into two the portions 320a and 321a along the axial direction. However, the portions 320a and 321a in each slot 311 may be overlapped with each other in the axial direction on condition that a gravity center of the portion 320a is further away from the shaft 30 than a gravity center of the portion 321a.

Further, each of the portions 320a and 321a in each slot 311 is formed in a rectangular shape in section to substantially form no opening in the slot 311 formed in a rectangular shape in section. However, each of the portions 320a and 321a and the slot 311 may have an arbitrary sectional shape on condition that no opening is substantially formed in the slot 311.

Moreover, the number of slot-received portions in each slot 311 is two. However, the number of slot-received portions in each slot 311 may be three or more. In this case, a sectional area of one portion is set to be larger than a sectional area of another portion placed nearer to the shaft 30 than the one portion.

Furthermore, the portion 321a covered with two insulating films and the portion 320a covered with a single insulating film may be disposed in each slot 311 so as to set a sectional area of the portion 320a to be larger than a sectional area of the portion 321a by a sectional area of one insulating film.

Still further, a boundary line between the portions 320a and 321a in each slot 311 may be curved.

Still further, the stator 2 has the permanent magnets 21. However, in place of the magnets 21, the stator 2 may have at least one coil wound around an exciting core such that magnetic fluxes are induced in response to an exciting current supplied to the coil so as to arrange N and S magnetic poles along the circumferential direction.

### Embodiment 2

In a second embodiment, sectional shapes of slots and slot-received portions of the coil 32 are modified.

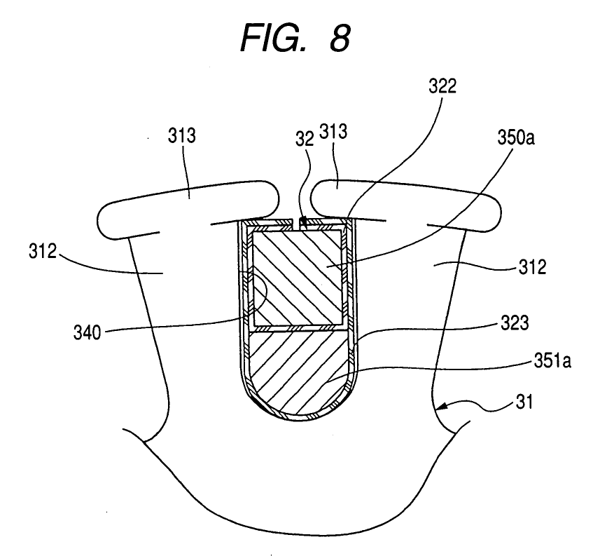

FIG. 8 is a sectional view of slot-received portions of the coil 32 received in one slot 311 of the armature core 31 according to a second embodiment.

As shown in FIG. 8, the core 31 has a plurality of slots 340 in place of the slots 311. The slots 340 differs from the slots 311 in that each slot 340 is formed in a U shape in section. More specifically, a wall of the core 32 is rounded at a bottom of each slot 340 nearest to the shaft 30 so as not to form any corner in the slot 340. A sectional shape of the slot 340 is partitioned into an upper region having a square shape in section and a lower region having a semicircle and rectangular shape in section.

Each coil part 320 of the coil 32 has a slot-received portion (or intermediate portion) 350a and the two linking portions 320b and 320c. The portion 350a is formed in a bar shape and almost in a square in section so as to have four sides set at the same length. The portions 350a are received in the upper layers of the slots 340, respectively. A side of the portion 350a is set to be parallel to the radial direction, and another side of the portion 350a is perpendicular to the radial direction.

Each coil part 321 of the coil 32 has a slot-received portion (or intermediate portion) 351a and the two linking portions 321b and 321c. The portion 351a is formed in a bar shape and almost in a semicircle and rectangular shape (or U-shape) in section so as to have a side facing one side of the portion 350a. The side of the portion 351a has the same length as the side of the portion 350a has. The semicircle of the portion 351a is placed at the deepest position of the slot 340 so as to direct a rounded surface of the portion 351a toward the shaft 30.

A sectional area of the portion 350a is set to be larger than a sectional area of the portion 351a.

For electric insulation, almost the whole outer circumferential surface of the portion 350a is covered with the upper layer insulating film 322, and almost the whole outer circumferential surface of both the portion 351a and the portion 350a covered with the film 322 is covered with the lower layer insulating film 323. Therefore, the portions 350a and 351a and the core 31 are insulated from one another in the same manner as the portions 320a and 321a and the core 31 are insulated. Because the portions 350a and 351a facing each other have the respective sides set at almost the same length along the circumferential direction, the coil 32 with the films 322 and 323 has a straight side parallel to the radial direction.

With this structure, the machine 1 is operated in the same manner as in the first embodiment, and the portions 350a and the portions 351a are heated substantially at the same moderate temperature in the same manner as in the first embodiment.

Accordingly, because the portion 351a has a rounded surface along a rounded bottom of the slot 340 at the deepest position of the slot 340 so as not to have a sharp corner, the rounded surface of the portion 351a can prevent the insulating film 323 from being broken.

Further, because the slot 340 has no corners at the deepest position thereof, life of a metallic mold used for pressing and shaping a magnetic substance to form the core 31 can be lengthened. Accordingly, the machine 1 can be manufactured at a low cost.

What is claimed is:

1. An electric rotating machine, comprising:
a rotor; and
a stator that generates a magnetic flux passing through the rotor,
wherein the rotor comprises an armature core substantially formed in a columnar shape and an armature coil wound on the armature core,
the armature core is rotatable around a center axis of the armature core,
the armature core has a plurality of slots aligned along a circumferential direction of the armature core such that each of the slots extends substantially along an axial direction of the armature core and has an upper region and a lower region nearer to the center axis of the armature core than the upper region,
the armature coil has a plurality of upper layer coil parts and a plurality of lower layer coil parts connected with one another,
the upper layer coil parts are received in the respective upper regions of the slots,
the lower layer coil parts being received in the respective lower regions of the slots; and
a sectional area of the upper layer coil part received in each slot is set to be larger than a sectional area of the lower layer coil part received in the slot.

2. The machine according to claim 1, wherein the upper layer coil part received in each slot has a sectional shape differentiated from a sectional shape of the lower layer coil part received in the slot so as to set a width of the upper layer coil part along the circumferential direction to be substantially equal to a width of the lower layer coil part along the circumferential direction.

3. The machine according to claim 1, wherein a wall of the armature core has a rounded wall facing the lower region of each slot.

4. The machine according to claim 1, wherein the upper layer coil part received in each slot has a rectangular shape in section and has a shorter side substantially perpendicular to a radial direction of the armature core.

5. The machine according to claim 1, wherein each of the upper and lower layer coil parts has an intermediate portion and two end portions, respectively, connected with ends of the intermediate portion, the intermediate portion of the upper layer coil part and the intermediate portion of the lower layer coil part are, respectively, disposed in the upper and lower regions of each slot, and a sectional area of the intermediate portion of the upper layer coil part is set to be larger than a sectional area of the intermediate portion of the lower layer coil part.

6. The machine according to claim 1, wherein the upper and lower regions in each slot are arranged along a radial direction of the armature core.
